(19) United States
(12) Patent Application Publication
(10) Pub. No.: US 2026/0261591 A1
(43) Pub. Date: Sep. 3, 2026

(54) SYSTEM AND APPARATUS FOR STREAMING, DISCOVERING, AND SHARING GEO-SPATIAL MEDIA CONTENT

(71) Applicant: Freddy S. Baez, New York, NY (US)

(72) Inventor: Freddy S. Baez, New York, NY (US)

(21) Appl. No.: 19/056,664

(22) Filed: Feb. 18, 2025

Related U.S. Application Data
(63) Continuation-in-part of application No. 17/533,473, filed on Nov. 23, 2021, now abandoned.

(51) Int. Cl. H04L 65/611; G06F 3/0482; G06F 16/65; H04W 4/021

(52) U.S. Cl. CPC H04L 65/611; G06F 16/65; H04W 4/021; G06F 3/0482

(57) ABSTRACT

A system which integrates digital music sharing, broadcasting, dissemination, and sales so that a single software application on a communications device such as a smartphone or laptop will allow an end user to access, distribute (stream), broadcast, or sell music across all platforms including live radio broadcasts. A key aspect of the invention is that a user may decide upon a geographical or cultural preference when seeking music.

### FIELD OF THE INVENTION

The present invention relates generally to streaming services. More particularly, the invention relates to a comprehensive social music platform that integrates live radio, music streaming, interactive map, social media, analytics, and sales and is useful for end users, broadcasters, artists, and music organizations.

### BACKGROUND OF THE INVENTION

Since the advent of the internet, the music industry has undergone a significant transformation due to technological advances that helped shift the music distribution landscape from analog to digital. Numerous music services and platforms have emerged for the purpose of providing users with easy access to large amount of digital music and information. End users, broadcasters, artists, and music organizations have all benefitted from the ease of accessing, acquiring, exchanging, producing, commercializing, or simply enjoying a vast array of digitally encoded music across many media platforms; including peer to peer file sharing, and over the air radio broadcasts.

The amount of global music available on the internet and media platforms is ever-increasing and overwhelming. Furthermore, music data is incomplete, unorganized, and scattered; therefore, hindering users from discovering music culturally, geographically and in real-world.

It would be desirable to provide a single platform or software application to consolidate the various ways that digital music is discovered, organized, and experienced among and between end users, broadcasters, artists, and music organizations. Also, it is desirable to provide a method and apparatus to allow users to search, discover, interact, disseminate, and enjoy music based on geographic location and in real-world.

### SUMMARY OF THE INVENTION

A system which integrates live radio, music streaming, interactive map, social media, analytics, and sales on a single platform tightly coupled with a software application operating across different communication devices such smartphone, laptop, and home & in-car entertainment system. End users can interact by accessing, disseminating, or simply enjoying interactive music streams and events within its social music community. A key aspect of the invention is its capabilities of empowering end users to discover and experience world culture and music by allowing them to scan geographic regions for content. The system's innovative geospatial methods and objects revolutionizes the way people consume and disseminate music and other media geographically.

It is a major object of the invention to provide an improved digital music platform.

It is another object of the invention to provide an improved digital music platform application that can be used by end users, broadcasters, artists, and other music industries and organizations.

It is another object of the invention to provide an improved digital music platform application that can provide personalized content and functionalities based on end user's system interactions and activities. It is another object of the invention to provide an improved digital music platform application that can be used on a variety of devices.

It is another object of the invention to provide an improved digital music platform that can deliver interactive streaming to 1-to-many and many-to-many users.

It is another object of the invention to provide an improved digital music platform that can be used for music synchronization sessions between 1-to-many and many-to-many users.

It is another object of the invention to provide an improved digital music platform that can be used for music sharing.

It is another object of the invention to provide an improved digital music platform that can provide a music social network that allows interactions between users, artists, and broadcasters.

It is another object of the invention to provide an improved digital music platform that allows content to be organized geographically.

It is another object of the invention to provide an improved digital music platform that allows a user to navigate through content by interacting with a geospatial map interface. It is another object of the invention to provide an improved digital music platform that allows a user to filter and choose a geographical or cultural preference by navigating to a specific geographic region for content.

### BRIEF DESCRIPTION OF THE DRAWINGS

FIG. 1 is a diagrammatic overview of the system of the invention.

FIG. 1B is a diagrammatic representation of the system environment.

FIG. 2 shows a capture of the home screen of the application depicting an interface for facilitating the mapping function of the system of the invention.

FIG. 3 shows a capture of the area list screen of the application depicting an interface for facilitating a list of artists and stations within the area of the system of the invention.

FIG. 4 shows a capture of the media player screen of the application depicting an interface for facilitating media control for playback of the system of the invention.

FIG. 5 shows a capture of the album screen of the application depicting an interface for facilitating song information including associated album, artist, and video of the system of the invention.

FIG. 6 shows a capture of the music charts screen of the application depicting an interface for facilitating music charts and trends by country of the system of the invention.

FIG. 7 shows a capture of the user ‘fan’ profile screen of the application depicting an interface for facilitating user information of the system of the invention.

FIG. 8 shows a capture of the artist profile screen of the application depicting an interface for facilitating artist information of the system of the invention.

FIG. 9 shows a capture of the radio station profile screen of the application depicting an interface for facilitating radio station information of the system of the invention.

FIG. 10 shows a capture of the radio station chat screen of the application depicting an interface for facilitating public chat room and music recognition of the system of the invention.

FIG. 11 shows a capture of the user incoming call screen of the application depicting an interface for facilitating two-way audio/video communication of the system of the invention.

FIG. 12 shows a capture of the live chat room screen of the application depicting an interface for facilitating live audio/video communication chat of the system of the invention.

FIG. 13 shows a capture of the message summary screen of the application depicting an interface for facilitating user messages and notifications communication of the system of the invention.

FIG. 14 shows a capture of the user comment screen of the application depicting an interface for facilitating user commenting messages of the system of the invention.

FIG. 15 shows a capture of the search screen of the application depicting an interface for facilitating content search of the system of the invention.

FIG. 16 shows a capture of the filter screen of the application depicting an interface for facilitating content filtering of the system of the invention.

FIG. 17 shows a capture of the share screen of the application depicting an interface for facilitating content sharing of the system of the invention.

FIG. 18 shows a capture of the start a message screen of the application depicting an interface for facilitating messaging between 1-to-many users of the system of the invention.

FIG. 19 shows a capture of the user music synchronization screen of the application depicting an interface for initiating music synchronization between end users of the system of the invention.

FIG. 20 shows a capture of the user synching screen of the application depicting an interface for facilitating the start of live music synchronization process of the system of the invention.

FIG. 21 shows a capture of the user sync request screen of the application depicting an interface for facilitating the request of live music synchronization process of the system of the invention.

FIG. 22 shows a capture of the user sync ended screen of the application depicting an interface for facilitating the ending of live music synchronization process of the system of the invention.

FIG. 23 shows a capture of the play button navigation menu of the application depicting an interface for facilitating different music playback states of the system of the invention.

### DETAILED DESCRIPTION

The present invention is directed to a system or platform which integrates live radio, music streaming, interactive map, social media, analytics, sales, and dissemination so that a single software application on a communication device will allow the end user to connect, access, share, stream, or sell music across the platform including interactive live radio broadcasts and events. A key aspect of the invention is that the end user may decide upon a geographical or cultural preference when seeking music. The system allows a user to scan music, radio stations or other media content based on geographic position so that a user may scan a particular region from, e.g., east to west, with content providers appearing in a scrollable list depending upon their relative location as explained in more detail below.

As used herein “Communications device” is defined as any computer (e.g., desktop, laptop, and/or tablet), phone, smartphone, virtual reality (VR) device, augmented reality (AR) device, personal digital assistant (PDA), or computing device that comprises a battery, display, circuit board, and processor capable of processing or executing software.

A graphic user interface (“GUI”) allows users to interact with communications devices through icons and other visual indicators presented on a display.

A “smartphone” (or “smart phone”) is a mobile telephone with more advanced computing capability and connectivity than basic feature phones. Smartphones typically include the features of a telephone combined with one or more features of other popular consumer devices, for example including but not limited to a personal digital assistant, media player, audio speakers, digital camera, and/or a GPS navigation unit. Smartphones typically include features such as a touchscreen interface, web browsing, broadband network radio (e.g., LTE), Wi-Fi, Bluetooth, and 3rd-party apps.

“Content” refers to, but is not limited to, media (e.g., audio, video, images), streaming, broadcasting, interactive chat, messaging, data, sharing (e.g., syncing with other music listeners), etc.

“Content provider” includes, but is not limited to, broadcasters, artists, end users, streaming services, etc. A content provider may use a communications device other than a smart phone.

“End user” or “User” refers to individuals accessing the system solely for the purpose of browsing, selecting, and accessing content available on the system.

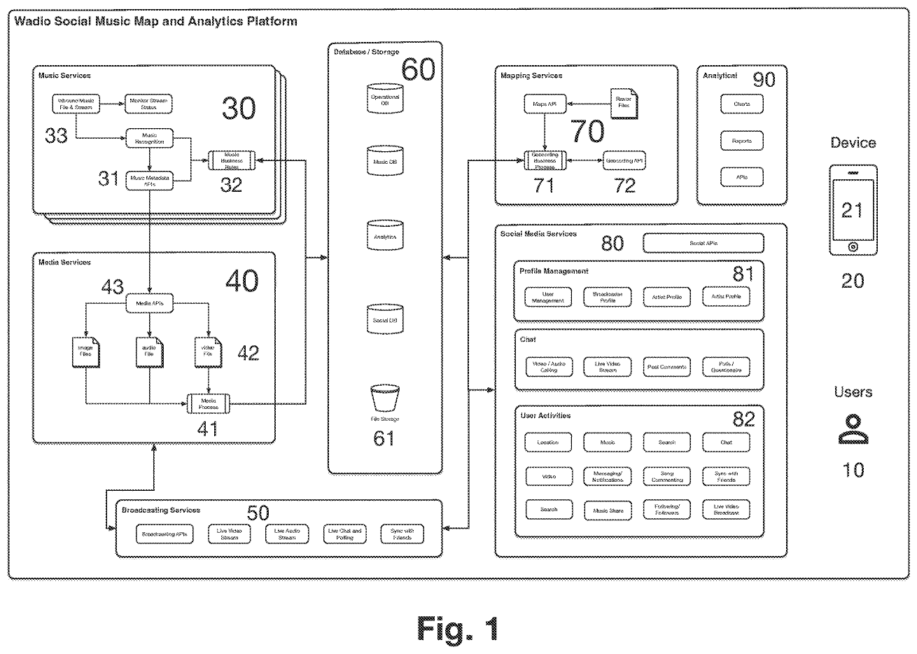

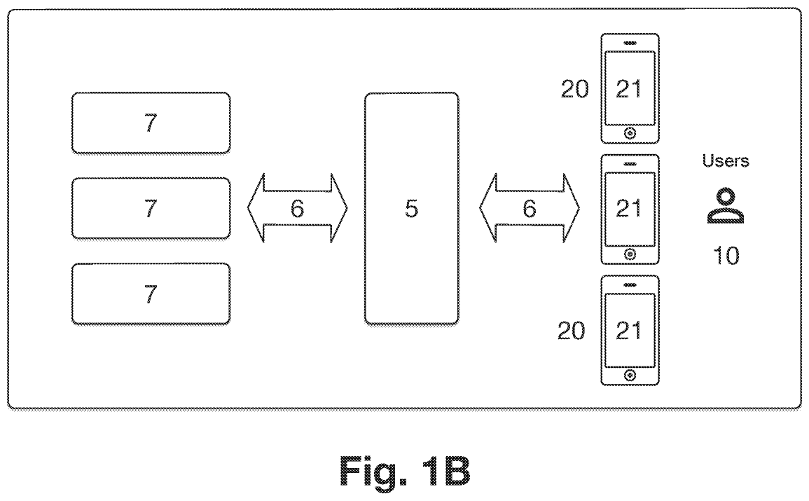

Referring now to FIGS. 1 and 1B, the system of the invention, generally indicated by the numeral 1, is diagrammatically illustrated. The system 1 allows content providers 7 the ability to disseminate searchable content via the internet 6 to user's communications devices 20 having access to the internet, and several components. The communications device 20 includes a display 21 in the form of a touchscreen which can present GUIs to allow the user to access various features of the system as will be described below. The system 1 allows each user 10 to access all available content from internet accessible content providers 7 such as broadcasters 50 (e.g., terrestrial, and digital radio stations), artists, and music streaming services on their communications device 20, which is preferably a smart phone. All content on the system is processed by a central server 5 which allows for the identification, categorization, storage, and dissemination of the content to requesting users. The central server 5 has an operating system which allows for receiving, processing, storing, and transmitting digital media files in the well-known manner. The exact methods and protocols for file transfer do not form a part of the invention unless otherwise noted. Content on the system 1 includes, but is not limited to, streaming, broadcasting, social media, mapping, analytics, interactive chat, and hosted talk shows (e.g., talk radio). The system also allows users to share files by syncing, as will be explained in more detail later.

The system 1 is implemented using the internet 6 to allow for communication between the various users 10 via communication device 20, a central server 5, and content providers 7. The central server 5 can be accessed by users and content providers 7 alike via the internet 6 in the well-known manner.

The system 1 has several components which are coordinated to provide the various functions as described below. The music services component 30, which is software implemented on the central server 5 (as are all components of the system as described below), process music files to facilitate some of the various processes provided by the inventive system. All the music files available on the system 1 are passed through the music services component 30 using various digital information transformation and exchange protocols as are known in the art. The inbound music file & stream sub-component 33, process uploaded music files, music streams, or otherwise provided via the various content providers 7 and user devices 20 connected to the system 1, in the form of a digitized audio/video signal or file. If the inbound music file & stream 33 has no identifying metadata, the file & stream 33 data is compared to the music files stored on the central database 60 associated with central server 5 to determine if there is a match, that is, if the music file & stream 33 has been previously stored in the database and thus has song and music metadata associated therewith. In the event of a match, the requesting user receives the identifying song and artist metadata, which is displayed on the device 20 (along with identifying graphics) as the music plays. If there is no match, the music file & stream 33 is sent to third-party metadata providers to determine if there is a match. If so, the metadata is attached to the music & stream and the file and associated metadata are stored in central database 60 and file storage 61. The music business rules sub-component 32 verifies the data and updates any missing information in the central music database 60. All incoming data identified as a music & stream 33 from a content provider 7 is monitored for status and online activities. If any music & stream 33 has no digitized musical audio, the content provider 7 is flagged and reported.

Media services 40 processes all of the digital media files 42 uploaded to the system via the various content providers 7 and devices 20, and stores them in a file storage device 61 associated with the central server 5 for later retrieval. Each digital media file stored in device 61 is uploaded and processed by the media process 41 via music metadata API 31 and media API 43 to obtain artist, album, track, broadcaster, video, or other metadata associated with the uploaded file. Once the metadata is obtained, the file (along with previously uploaded files) can be accessed by the content provider 7 that initially uploaded it, allowing them to manage their files stored on file storage 61 for other users to consume it. Compression algorithms may be performed and applied to audio, video, and image files by the media process 41 to reduce the file size in the well-known manner. Once the uploaded music file from the content provider 7 is associated with identifying metadata, the central database 60 is updated with a media file storage 61 and a signed URL is generated for users to consume the content securely. Content providers 7 can record live events, which events may be uploaded in real time to central server 5 for processing, with a digital recording of the event stored on file storage 61 after processing in the manner described above.

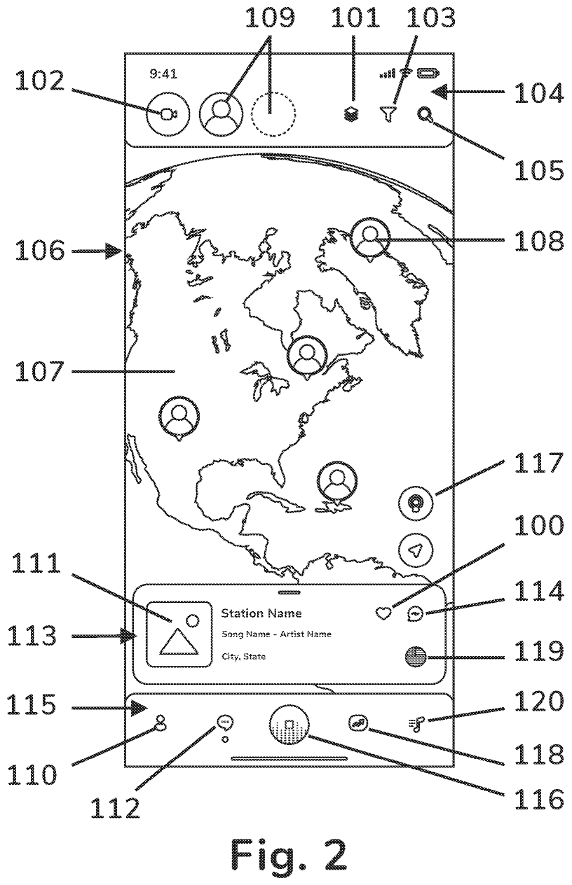

A key aspect of the inventive system is the mapping service 70. This service allows users to locate content and content providers based on geographical location. Referring now to FIG. 2, a screen capture of the home screen of the user application, which screen appears after user sign-in, of the system 1 illustrating an interface for facilitating the mapping service 70 is shown. It should be noted that some of the screen captures are scrolled versions, that is, all the images that can be seen scrolling the screen are presented as a single screen for explanatory purposes. The top row 104 shows several control GUIs including a video GUI 102 for live streaming, a search GUI 105 for searching content, a map layer GUI 101 for selecting a map overlay, and a filter GUI 103 for filtering content. User avatar GUI 109 is presented dynamically when content provider 7 starts a live audio/video communication session. Screen 106 displays a rotatable three-dimensional world map 107. A plurality of selectable radio station GUIs 108 is displayed in various positions on the world map, the positions corresponding to the actual physical location of the radio station, with each GUI 108 representing a radio station providing content. Thus, radio stations that are content providers 7, in the instant case terrestrial and digital radio stations, are represented as GUI images 108 such as avatars positioned at the geographical location of the station. The mapping services 70 provides mapping capabilities to the application where users can rotate (by swiping the display 106 in the known manner) the world map globe GUI 107 on their device 20 to tune in to music by tapping on (selecting) a particular GUI such as an avatar GUI 108 in a country or region of interest. Users can search GUI 105 for content based on language and/or country or by simply rotating the world map GUI 107 to a desired region, and then selecting a GUI 108 of interest. The world map GUI 107 may be expanded (in the well-known manner for magnifying smart phone/laptop screen images) to reveal more detail and allow the user to select among closely spaced or clustered stations in large metropolitan areas like large cities. Artists, events, talk shows, and advertisement in the selected geographic area may also be displayed as, e.g., actual images or avatars on the world map GUI 107, with other content providers 7 using representative GUI images 108. The geocoding business sub-component process 71 detects when new content providers 7 upload content to the system 1 and calls the geocoding API 72 to retrieve location information of the uploading provider. The mapping service 70 uses radio station location data, public artist birthplace information, and other data relating to uploading content providers 7 to geocode the GPS coordinates of the country and city of the uploaded music file. Once obtained, the location allows the system 1 to display content providers 7 (other than terrestrial radio stations which are positionally fixed) on the GUI 107 based on place of origin as opposed to their current physical location.

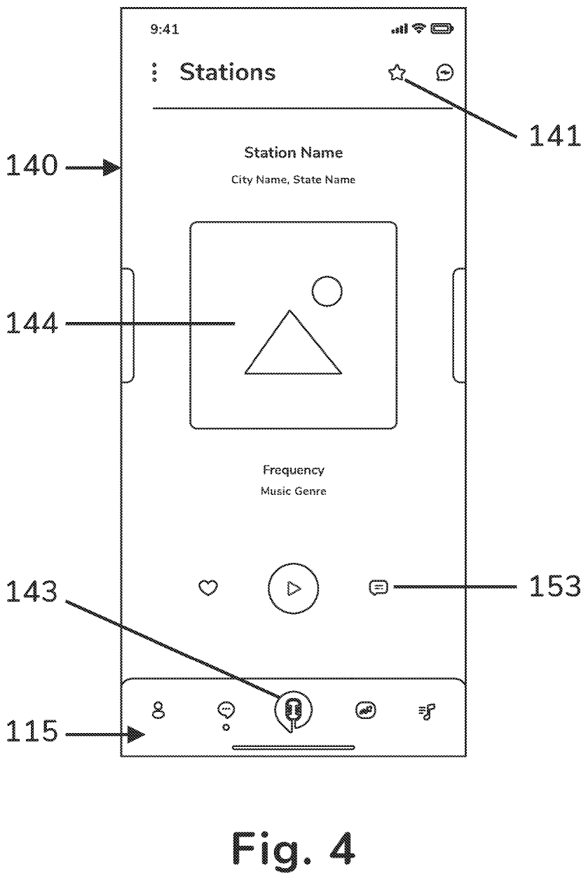

The selected station name (or the name of the last station played before signing out of the inventive application) and an identifying logo 111 (if available) are presented on the scrolling station deck 113 and which area is scrollable and includes a heart icon 100, a country icon 119, and a dialog or “chat” box icon 114. The chat box icon 114 allows the user to enter an interactive public group chat with the radio station operator/disc jockey. The country icon 119 allows the user to locate the country position on the map 107. The heart icon 100 allows the user to ‘like’ a station which is then added to the user's favorite list. The name of the song currently playing as well as the artist are displayed in this area 113 of the screen. The bottom area of the screen 106 includes a toolbar 115 having a number of control GUIs including a play/stop GUI 116, a trending up GUI 118 which allows for the display of charts and trending content, a user profile GUI 110 for displaying the user preferences and content, a message GUI 112 which allows users to receive system notifications and messages from other users and content providers, and a GUI 120 which allows for the presentation of a media player controls in FIG. 4.

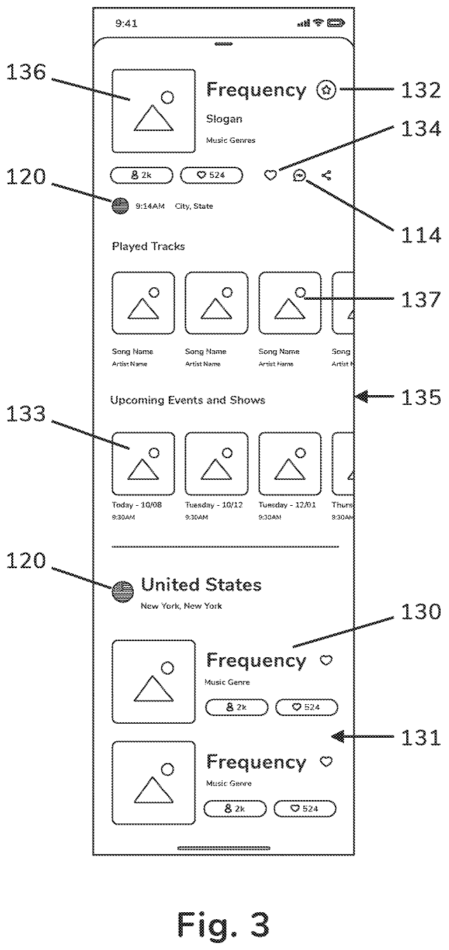

The application of the invention can effectively function as a geo-positional virtual radio tuner and music navigation system. As can be seen in FIG. 3, screen 135 is displayed after sliding the scrolling station deck GUI 113 upwards. The selected station logo 1 is presented including information pertaining to the station followers, location, ‘likes’, and music genre. A star icon 132 allows user to add station to a preset list for quick retrieval when seeking for stations. A chat room icon 114 allows the user to enter an interactive public group chat with the radio station operator/disc jockey. A horizontal scrollable list of tracks played on the selected (current) station is shown as a row of GUIs 137, any of which can be selected to display information about both artist and song. Radio stations 130 in the geographic vicinity of the selected GUI are displayed as a single scrollable column at the bottom of the screen 131. The row can be manipulated vertically to display all stations in the selected geographic area. The user can continually scroll the column of stations until all the stations in the selected vicinity are exhausted at which point the stations in the adjacent geographical area are displayed on the row 131. If, for example, the user selects a station on the east coast of say the United States, he can slide the row to the bottom to navigate all the way to the west coast stations on the system. Thus, a geographic virtual radio (or content) dial, allowing a user to select stations from e.g., east to west is provided. It can be appreciated that if the user selects a station in eastern South America for example, the stations presented will be Latino music stations with varying styles as the user progresses from east to west. This affords the user an unprecedented ability to enjoy music from various regions/cultures with relative ease and effort while discovering geography and various culture. If the user enjoys a particular station, user may assign the station as a favorite station by selecting the favorite icon 134.

The mapping services screen 106 (FIG. 2) can use other GUIs (in addition to the broadcast tower GUIs 108) to represent artists, music events, and live talk shows that will pop up when a match is found for the artists' music that is currently playing. That is, other GUIs than the broadcast tower GUIs will populate the mapping services screen 106 in response to either a user-initiated search 105, which search would be initiated on screen 106, or selected map layer 101 representing an upcoming event scheduled for the artist currently airing on the selected station, or artist birthplace. Upcoming music events, live shows, exclusive music, and music video releases can also be displayed as GUIs on the map 107, and can be presented in real time as soon as uploaded to the central server 5 by a content provider 7. Other GUIs and map styles can be selected and applied on mapping service screen 106 by choosing a map overlay preset 101.

In addition to the radio stations in the selected geographic vicinity, upcoming events in the selected vicinity having video, music, or chat content will be displayed as row of image GUIs 133 on the “music in the area” screen 135 as shown in FIG. 3. This screen, as do all others, also displays a graphic 119 of the flag of the country of residence of the content provider, which in this case is the selected radio station with identifying name and logo 136 positioned at the top of the screen.

In a key aspect of the invention, there are three main types of content providers, terrestrial radio stations, live events at “known” venues, and live events at restaurants, bars, or even private homes. Known venues are venues known to most people such as major concert halls, and established music venues like jazz clubs. In accordance with the invention, known venues are considered primary content providers because their schedules can easily be found with a simple internet search. Smaller venues, which in many cases offer music only upon occasion or for, e.g., weekend brunches, typically do not have schedules that are posted in an internet accessible manner. These smaller venues are considered secondary content providers for purposes of the inventive method. It is well known that scheduling information for secondary content providers is very difficult to impossible to find as the artists providing the content may have little to no local recognition and do not advertise. The present invention uses three techniques to populate the list of secondary content providers for display. First, a website is created for the sole purpose of obtaining secondary content provider concert/performance data. The website would be associated with an organization that actively seeks listings for any performance art. Secondly, using the software downloaded as described above, a user may scan any poster, flyer, etc. that has artist data with his/her smartphone. The smartphone can scan the poster and obtain all of the necessary data to generate a listing. Once scanned, the image will necessarily include performer name and performance dates and times, but will not always include the genre or type of music, or even the city/state. For example, the flyer/poster image typically only has the street name and house or business number but not necessarily the city or state as this is often assumed known because of the placement of the flyer. A flyer for a performance at a local restaurant may only include the restaurant name if the flyer is in the same neighborhood as the venue. The inventive software can then perform the tasks of associating the flyer scan with a location using, e.g., cell phone tower data or GPS. Also, the software can scan the music database to find the content provider information such as genre, name, and birthplace or origin of the content provider, assuming the performer is already in the database. The inventive method provides a scheme for populating the list of content providers passively by just scanning a poster or flyer. Finally, the invention can use AI for an enhanced search for content, examining, e.g., newspaper articles, magazines covering a specific genre (e.g., Downbeat a jazz publication), video clips, etc. For example, a video clip of a touring artist where the artist states concert dates and times.

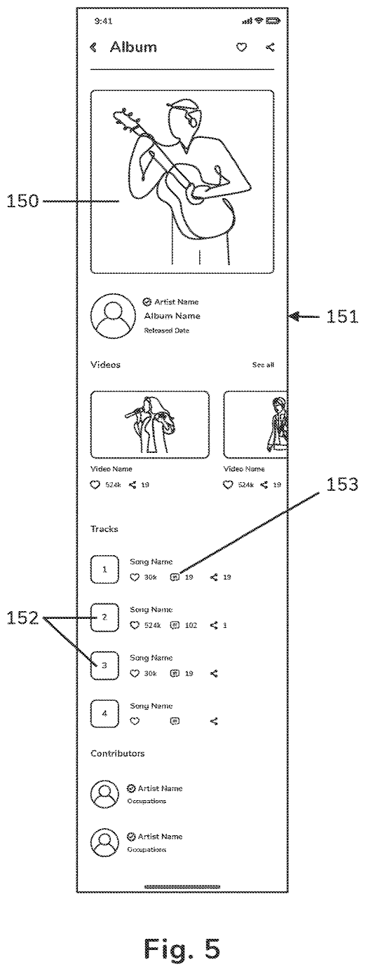

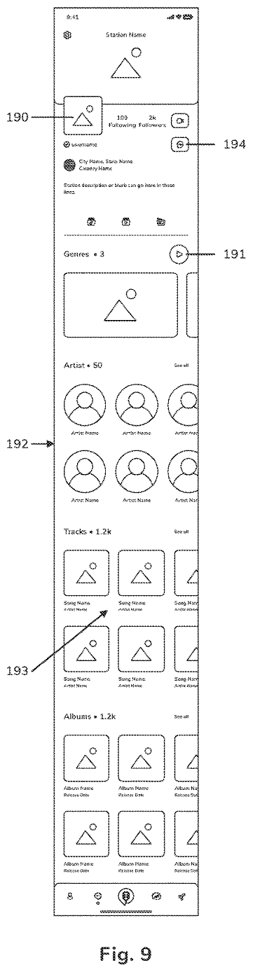

The station player screen 140 in FIG. 4 shows image 144 that can dynamically change from the station logo image to the album art image when music recognition of the current playing song is identified. Based on the state of the image 144, either the station details screen 192 (FIG. 9) or the song album screen 151 (FIG. 5) is displayed when selecting the image 144 as explained in more detail below. As can be seen in FIG. 5, the song album screen 151 presents the album art image 150 and all the tracks 152 on the album associated with the current track selected. The user may select any of the tracks 152 from the list, which will interrupt the currently playing song, and return the user to the broadcast when completed. Thus, the inventive application allows the user to explore and sample all the tracks from an album while the station plays a single song from the album. A star icon 141 allows user to add station to a preset list for quick retrieval when seeking for stations.

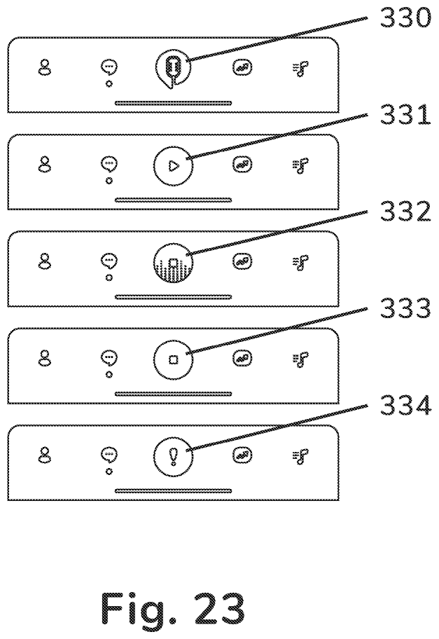

The station player screen 140 also includes the bottom row of GUI controls 115 to allow a user access to their profile, messages, home screen, and trending music. The microphone logo GUI 143 displayed on the bottom row 115 allows a user to access the mapping services ‘home’ screen 106. Also, GUI 143 can change states based on the music stream activity and status as presented in FIG. 23. The microphone logo GUI 143 can transition from inactive state 330 to play button 331. When the play button 331 is selected, the button transition to equalizer stop button 332. When the stop button 332 is selected, the button transitions back to inactive state 330. In the event the music stream is interrupted due to an error, the equalizer stop button 332 transition to the error report button 334, which allows the user to report the station stream issue back to the central server 5. In the event, that music stream is active but no audio, the stop button 333 is displayed without the equalizer. Other button states allow for haptic functions and menu popups allowing users to add the active song to favorite, follow artist, follow station, share, and set station preset.

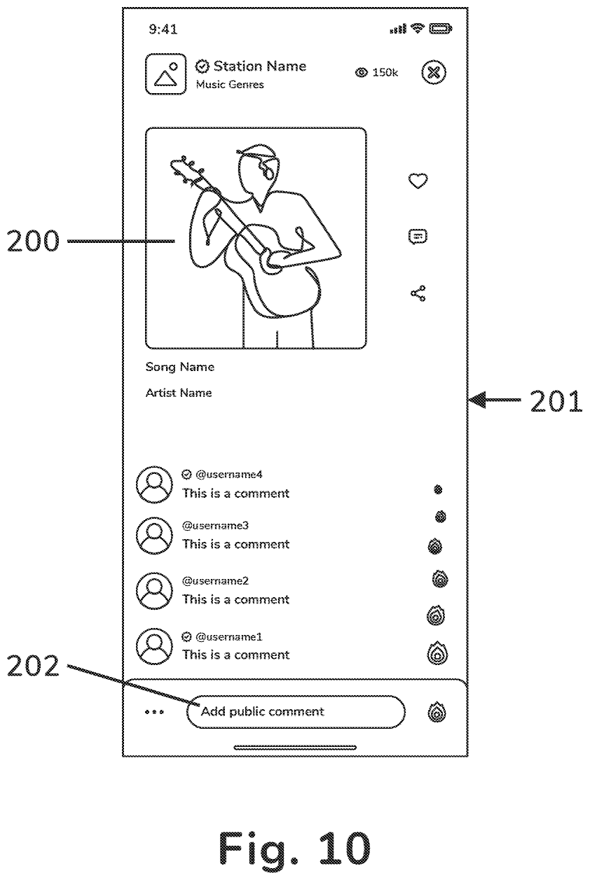

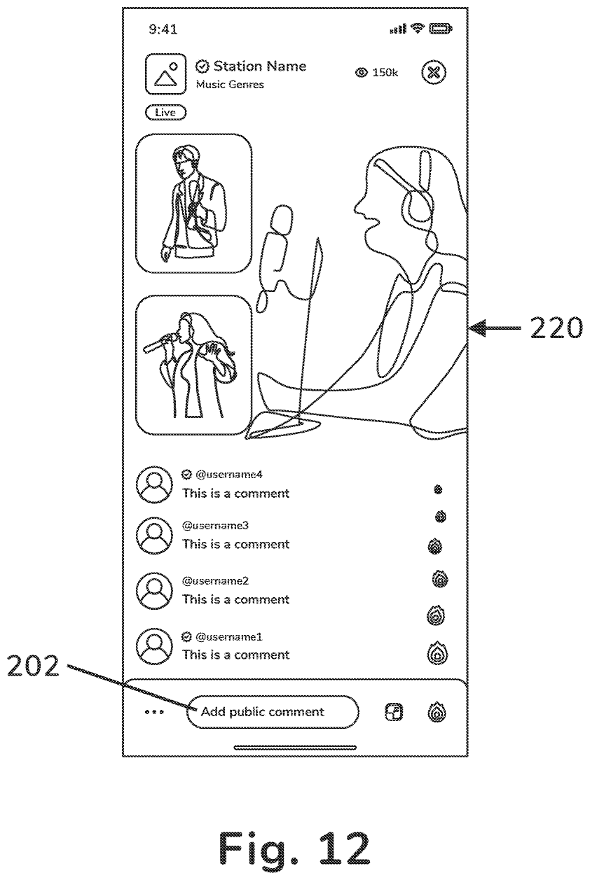

The broadcasting services 50 component allows for 1-to-1 and 1-to-many communication between artists, radio hosts, users, and broadcasters allowing for live streaming of shows, events, or chats to be shared among and between content providers 7 and users as represented in public chat room screen 201 and 220 in FIGS. 10 and 12. The public chat room is available for each station selected in the manner described above where any users can publicly communicate with other users, or the station host as discussed above. In addition, a station hosts can broadcast a poll or questionnaire where participants (users) can select an answer, the answers tabulated to produce the poll results and presented back to the user. In addition, users in the chat can buy live shoutouts made by the DJ and advertisement space which is displayed in-line with the chat text; a payment gateway is used for collecting the payments and sharing with the host.

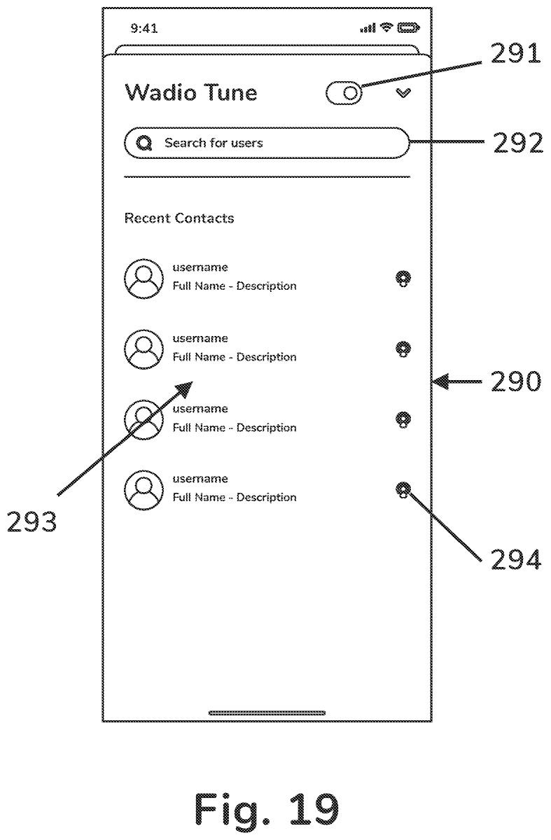

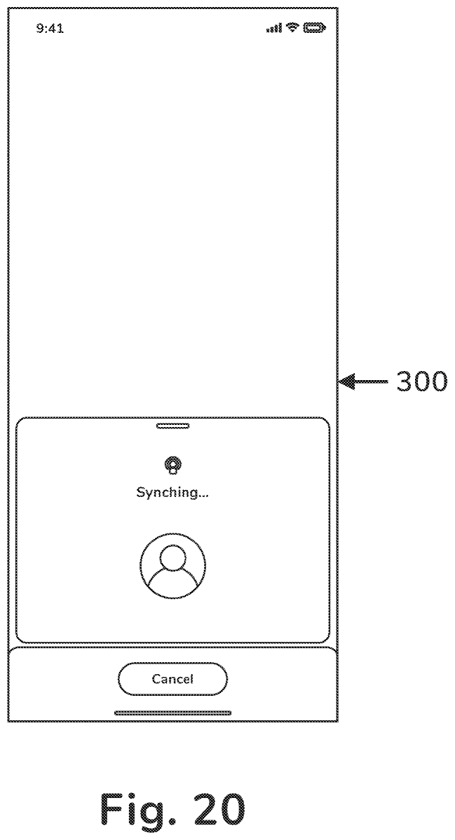

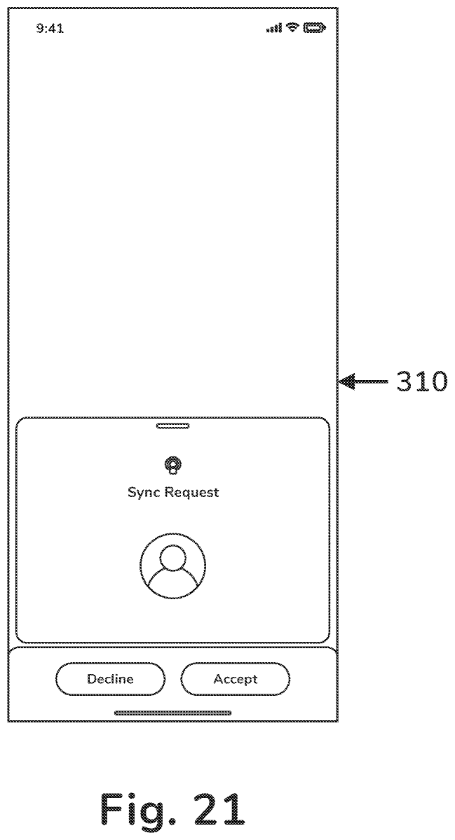

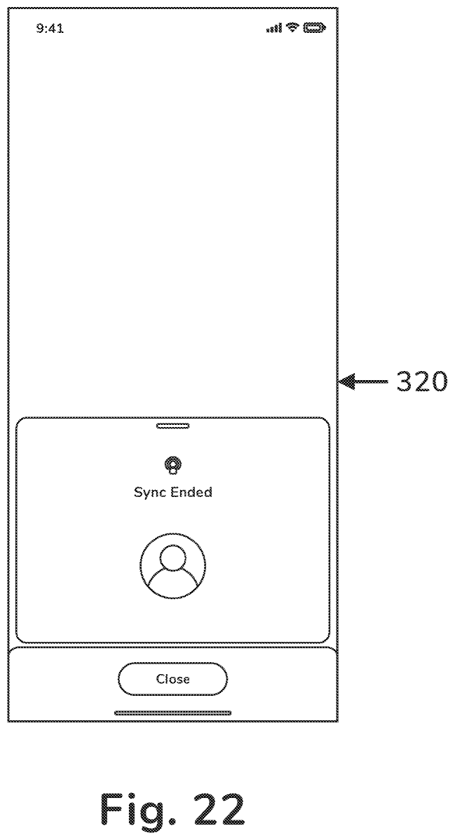

The broadcasting services component allows any user accessing the inventive platform to synchronize the music they are listening to with other users ‘friends’ or user groups in real-time. FIG. 19 shows a capture of the music synchronization ‘Wadio Tune’ screen 290 of the application depicting the interface for facilitating user with real-time music streaming synchronization with other users. User can activate or deactivate streaming synchronization requests by selecting the toggle switch 291; when deactivated, user stops receiving ‘Wadio Tune’ requests and GUI 294 is set to inactive on the corresponding user in the result list 293. The user search text input field GUI 292 allows searching of all registered users in the system and the results are presented in the user list 293 when text search match is found. User synchronization activity is presented with GUI 294, when active the GUI turns red in color when inactive the GUI turns green to indicate user's music synchronization availability with other. When a synchronization session is initiated, the user requesting synchronization is presented with synching screen 300 in FIG. 20 to indicate that the session request is started. The receiving user is presented with the sync request screen 310 in FIG. 21 which allows the receiving user to accept or decline the music synchronization request. In the event the request is accepted, the home screen 106 in FIG. 2 is presented allowing synced friends or any member of the user group to play a DJ role by listening to and playing music from various radio stations. This allows the “DJ” user to share and explore music content geographically and culturally together with ‘friends’ and all users within the active group. Music synchronization can be stopped or ended by any of the users in the session by selecting GUI 117 or 294 of FIGS. 2 and 19; in which case sync ended screen 320 in FIG. 22 is displayed and music streaming and synchronization is stopped. When user music synchronization is 1-to-1, synchronization ends for the session including both users. When music synchronization involves a group (1-to-many), synchronization ends only for the individual users who requested to end their synchronization while the remaining users continues uninterrupted.

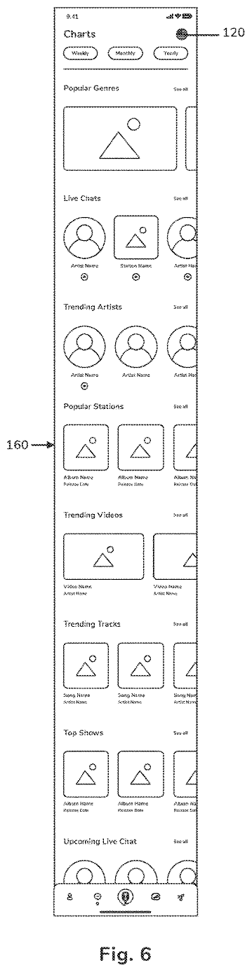

The analytical services component 90 captures and stores application usage activities from users and content providers 7 (users, radio stations, and artists) and stores the data on file storage 61 and database storage component 60. User activities 82 includes but not limited to music likes, follows, live events or shows, music plays, location, music shares, subscription, new music releases, and sales. The analytical services component 90 uses the activity data to populate and dynamically generate the music content chart screen 160 in FIG. 6. The chart screen of FIG. 6 provides popular and trending music, videos, live shows, stations, genres, and artists based on geography location for the country GUI 119 selected.

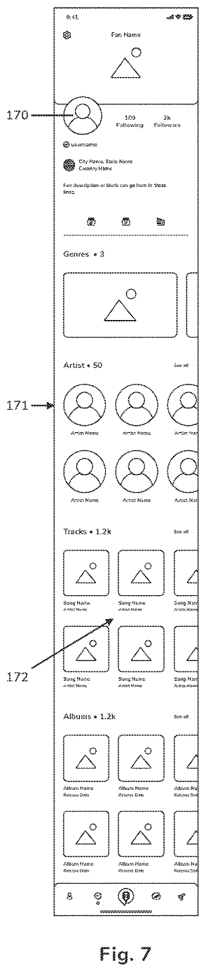

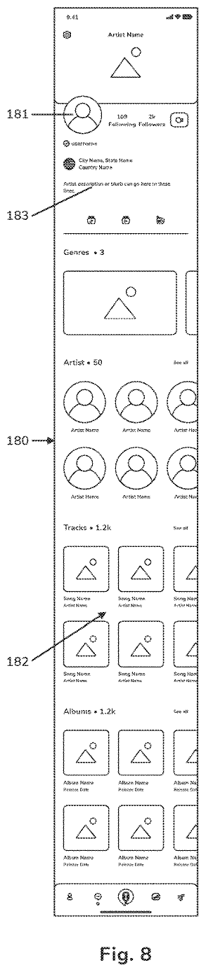

The social services component 80 provides profile management 81 and methods for each user to manage their user profile, including musical tastes, likes, followers, following, and settings for privacy, account, and notifications. Any user can register with the application by either visiting the home page associate with central server 5 or downloading the mobile app on Apple App Store or Google Play Store and providing the central server 5 with an email address, mobile number, and other identifying credentials as is known in the art. After application sign-in, user can manage their profile as depicted in screens 171, 151, and 192 in FIGS. 7, 8 and 9. A casual user ‘Fan’ profile screen 171 is shown in FIG. 7 which displays the user avatar 170 and has a scrollable list 172 of user's music taste, radio station, genres, and videos the user likes, follows, or subscribed to. The screen 171 is presented when the user selects on a casual user GUI or avatar as represented as shown and described in reference to the other screens of the application software. An artist profile screen 180 is shown in FIG. 8; this screen shows an artist avatar 181, and a scrollable list 182 to reveal albums, tracks, related artists, new releases, music videos, and genres for that artist. A short biography or blurb of the artist is also presented 183. Artist profile screen 180 can be accessed from any of the artists lists where the artist avatar is represented as shown and described in reference to the other screens of the application software. A station profile screen 192 is shown in FIG. 9, with the logo or other station identifier 190 displayed at the top. The station profile screen 192 is presented when the user selects on a station GUI or station avatar as represented as shown and described in reference to the other screens of the application software. The station profile screen 192 shows a scrollable list 193 with the albums, tracks, music videos, artists, and genres that are played on that radio station. Playback button 191, when selected will interrupt the current broadcast to playback music from the active station stream. The chat box icon 194 allows the user to enter the station public chat room screen 201 and 220 (FIGS. 10 and 12). Chat room screen 201 and 220 (FIGS. 10 and 12) allows users to post comments publicly for everyone to see, including comments for the current music playing on the active station, with an artist image 200 presented top of screen 201. A text entry box 202 allows users to enter their own comments.

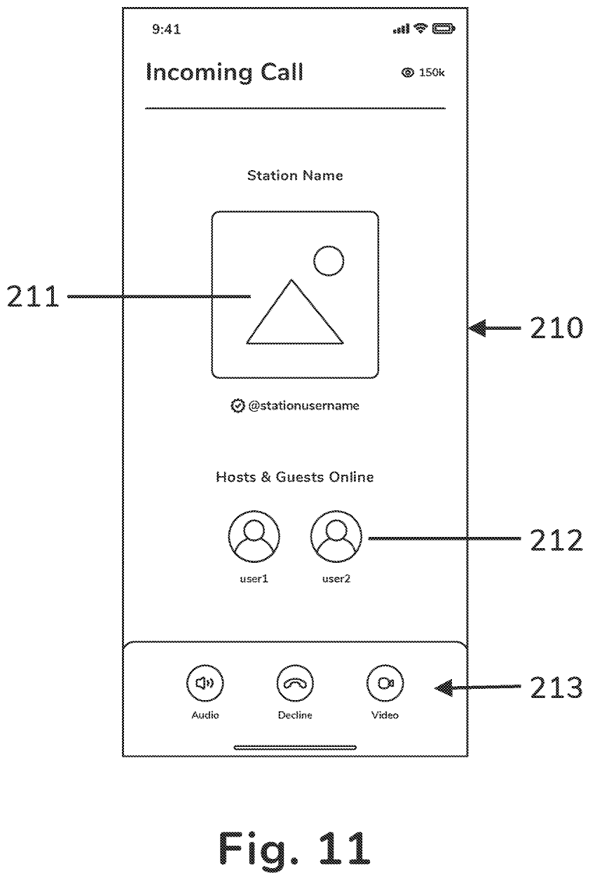

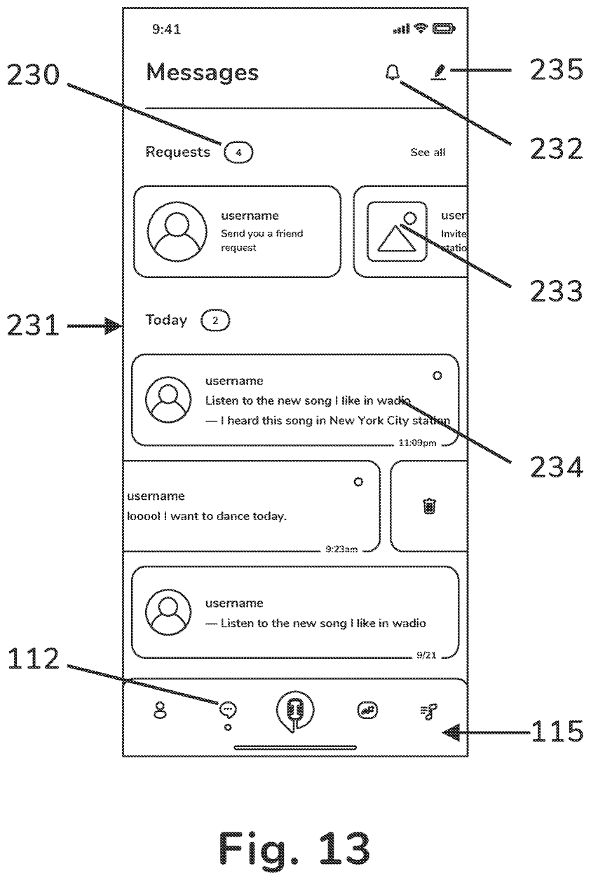

FIG. 11 shows a screen 210 displayed when a station, artist, or host initiates a live audio/video call session with another user. The host 211 and instant caller 212 images are shown on the screen 210, which is viewable by the caller and host. The user can decline or accept the incoming call by choosing between audio, video, or decline functionality presented in navigation bar 213. Once the incoming call is accepted, the user device 21 starts streaming audio/video to the chat room screen 220 (FIG. 12). All users in the chat room screen 220 can participate by commenting via the text entry box 202 on the bottom of the screen 220. In addition, system notification 232 (FIG. 13) is sent to the user when any of their subscribed station, artist, host, talk show, or event starts a live audio/video chat room session. User can join the live chat room screen 220 upon receiving the system notification.

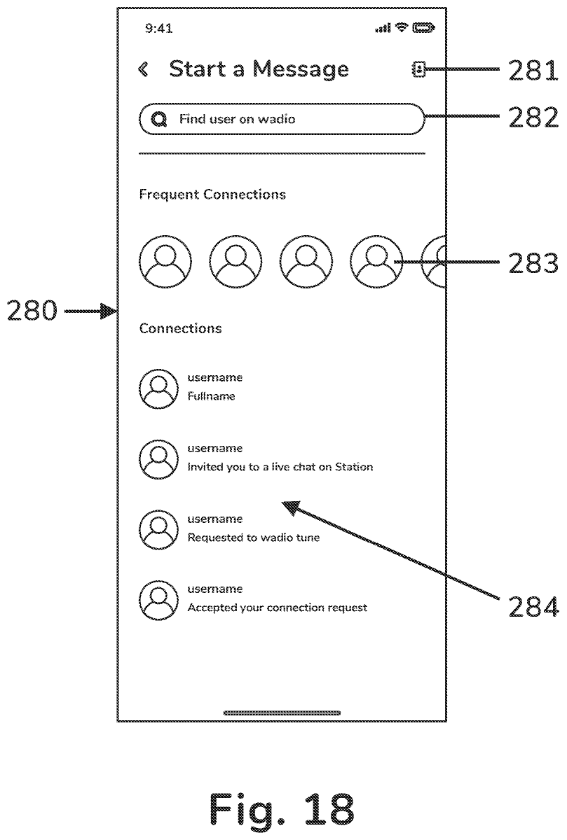

FIG. 13 shows a capture of the user message summary screen 231 of the application depicting an interface for facilitating user requests, messages, and notification communication of the system of the invention, which is presented by selecting on GUI 112. The number of requests is presented at the top of the screen via icon 230; the user can scroll horizontally the request list 233 to view other requests. User private messages are presented on the message list 234, which the user can scroll vertically to reveal other message communications between the user and other users or groups. To start a new message, the user can select the feather GUI 235, in which case the start new message screen 280 (FIG. 18) is presented. In addition, system notifications are presented when selecting GUI 232 (FIG. 13).

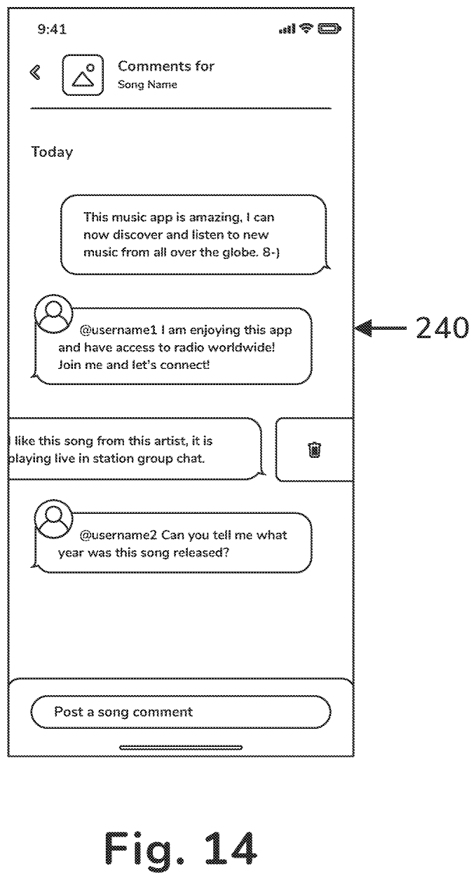

FIG. 4 shows a capture of the user song comment screen 240 of the application depicting an interface for facilitating user with song commenting functionality. User can comment on any selected song of the system of the invention. The screen 240 (FIG. 14) is presented when any song comment GUI 153 (FIGS. 4 and 5) is selected.

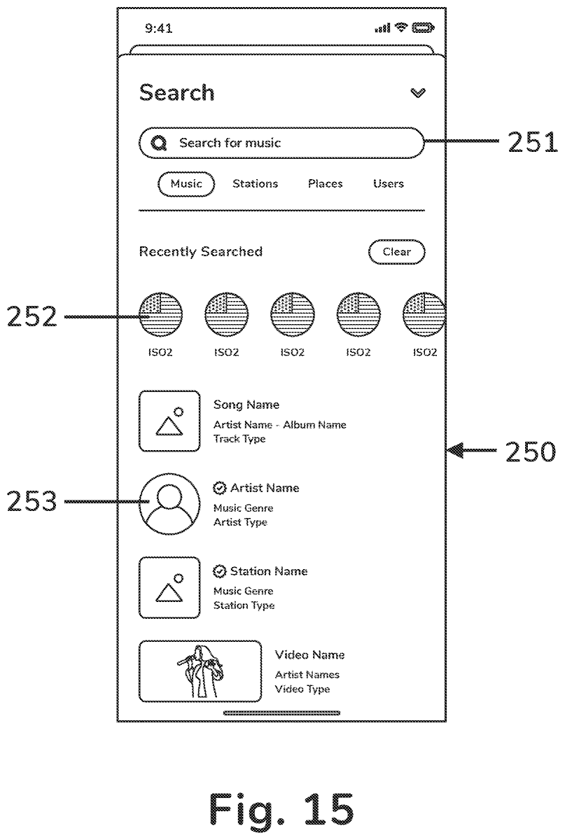

FIG. 15 shows a capture of the search screen 250 of the application depicting an interface for facilitating user with a content search text input field GUI 251 which allows user to search for content provided by content providers 7. Search results are presented as countries GUI 252 and various media types 253 such as cities, artist, station, music videos, music tracks, events, and talk shows.

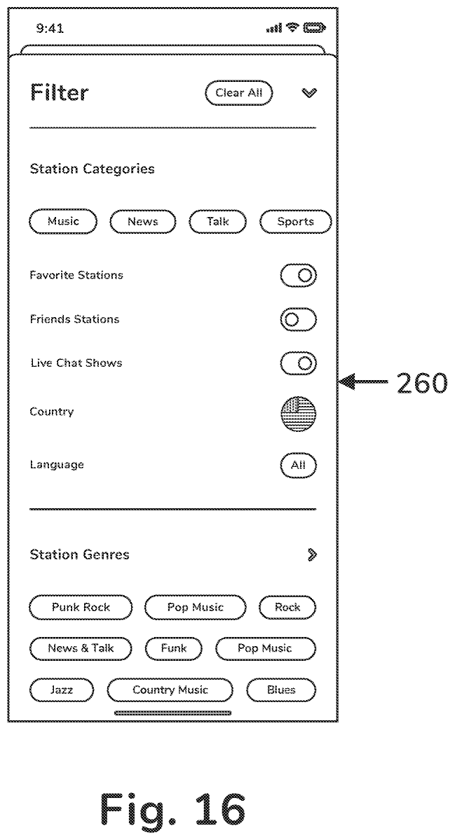

FIG. 16 shows a capture of the filter screen 260 of the application depicting an interface for facilitating user with various options for filtering content provided by content providers 7. Selected filters which can include station categories, favorite station, live chat show, country, language, or genre is then applied to the content and presented on the mapping services screen 106 (FIG. 2).

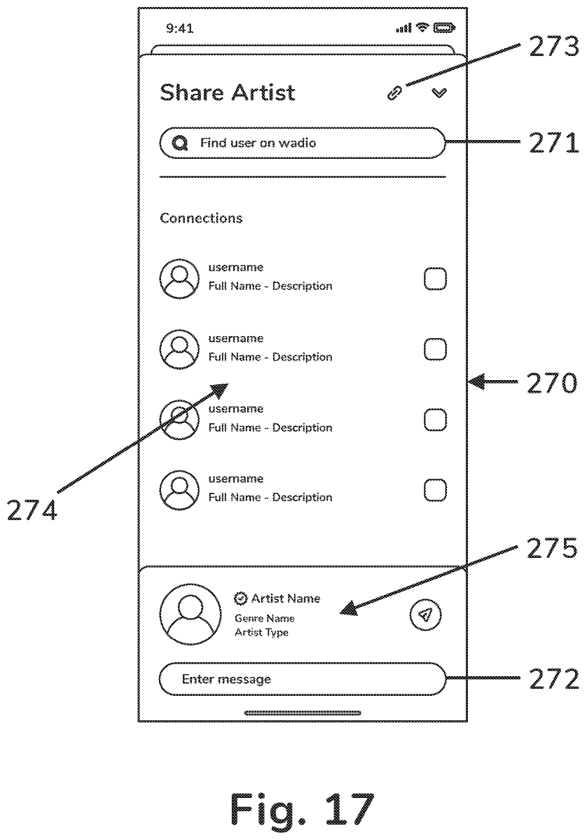

FIG. 17 shows a capture of the share screen 270 of the application depicting an interface for facilitating user with content sharing capabilities. The user search text input field GUI 271 allows user to search for other users registered in the system and a search result list 274 is presented when a match is found. User can select another user from the search result list 274 who they want to share the content 275 provided by content providers 7. User can include a message with content sharing by entering text in input field GUI 272. In addition, user can share content externally with another application on the user's device 20 by selecting the external share link GUI 273.

FIG. 18 shows a capture of the start message screen 280 of the application depicting an interface for facilitating users with messaging capabilities. The user search text input field GUI 282 allows user to search for other users registered in the system and a search result list 284 is presented when a match is found. User can select another user from the search result list 284 to whom they want to start messaging. If the user is not yet registered in the system, user can select from their phone contacts stored in their device 20 by selecting phonebook GUI 281. In addition, a scrollable list of frequent contacts 283 is presented on the top of the screen representing users that are contacted frequently and where user can select from frequent contacts to start messaging.

I claim:

1. A system for providing end users the ability to distribute, broadcast, disseminate, and share digitized music files from various content providers using a communications device having a display comprising:
a first component for identifying and categorizing of said music files, said first component processing all of said music files to identify unique identifiers associated with said files or providing a unique identifier for new files;
a second component for compiling and storing said files, and providing means for accessing said files;
a mapping component for determining content provider geographic locations to enable end users to search for said music files or tune to said radio stations based on geographic location, said mapping component receiving at least some data from end users, the data provided by said end users scanning images related to said content providers; and,
a broadcasting component broadcasting said music files reception by said end users.

2. The system of claim 1 wherein said communications device display is a touchscreen displaying GUI images.

3. The system of claim 2 wherein one of said GUI images is a world map, and said content providers are displayed on said map in a position relative to their actual geographic position.

4. The system of claim 1 wherein some of said content providers are terrestrial radio stations.

5. The system of claim 1 wherein some of said content providers are artists.

6. The system of claim 1 wherein said end users can become content providers.

7. The system of claim 3 wherein said world map GUI image can be manipulated to scan for content providers.

8. The system of claim 1 wherein said one to one or one to many broadcasts are from said artists and said radio stations to said end users.

9. The system of claim 1 wherein said broadcasts are from one end user to a plurality of other end users.

10. The system of claim 9 wherein one of said other end users can control content during said one to one or one to many broadcasts.

11. A system for distributing, broadcasting, disseminating, and sharing digitized music and video files over a communications network to end users, the system including at least one computer server connected to said network and executing various software components, the system comprising:
terrestrial radio stations and other primary content providers providing entertainment content to said end users, each of said end users having a communications device with a touch screen display, the communications device having some of said software components downloaded from said server;
secondary content providers providing exclusively live entertainment, a list of said secondary content providers generated using artificial intelligence to search for databases containing information regarding entertainment local to a specific geographic area, said databases having location, event time, and genre information, and said list including said location, event time, and genre information;
a music services component receiving, identifying, and categorizing said music files, said music services component processing all of said music files to identify unique identifiers associated with said files, said music services component also providing a unique identifier for music files not having unique identifiers previously associated therewith, the music services component outputting identified and categorized music files;
a media services component receiving said identified and categorized music files and said video files, the media services component compiling and storing said identified and categorized music files and said video files;
a mapping component determining each of said terrestrial radio stations, primary, and secondary content providers geographic locations, said mapping component also importing location information from said list of said secondary content providers, said mapping component generating a rotatable world map image and transmitting said rotatable world map image to said communications device for display on said touch screen display, said mapping component generating at least first and second types of GUIs for display on said world map image, each of said first types of GUIs representing one of said primary or secondary content providers and positioned on said world map image in accordance with a preferred geographic location associated with said one of said primary or secondary content providers;
a broadcasting component transmitting some of said identified and categorized music files, said live entertainment, or said video files one to many or one to one in response to a selection of one of said first types of GUI by one or more of said end users.

12. The system of claim 11 wherein said list of secondary providers is generated by end users scanning images.

13. The system of claim 11 wherein said images are posters or flyers associated with a specific performance by one of said secondary providers.

14. The system of claim 11 wherein said list of secondary providers is generated by analyzing video clips.
